(19) United States
(12) Patent Application Publication
(10) Pub. No.: US 2026/0084271 A1
(43) Pub. Date: Mar. 26, 2026

(54) IMPACT WRENCH

(71) Applicant: CEMBRE SPA., Brescia (BS) (IT)

(72) Inventors: Davide NICOLAI, Brescia (BS) (IT); Gualtiero BAREZZANI, Brescia (BS) (IT); Diego BORONI, Brescia (BS) (IT)

(21) Appl. No.: 19/332,919

(22) Filed: Sep. 18, 2025

(30) Foreign Application Priority Data
Sep. 20, 2024 (IT) 102024000021061

(51) Int. Cl. B25B 21/02; B25B 23/147; B25B 23/18; B25F 5/00

(52) U.S. Cl. CPC B25B 21/02; B25B 23/1475; B25B 23/18; B25F 5/006; B25F 5/008

(57) ABSTRACT

An impact wrench (1) with an upper handle assembly (2), a lower working assembly (3) and an intermediate connecting bar (4) connected between the handle assembly (2) and the working assembly (3) and comprising a tubular body (4′) with a first end portion (15) ( coupled with a first coupling seat (16) of the handle assembly (2) and a second end portion (17) coupled with a second coupling seat (18) of the working assembly (3), wherein the first end portion (15) and the first coupling seat (16) both have a non-circular or polygonal or rectangular or square cross-section, orthogonal to the longitudinal direction (14), so as to make an anti-rotation shape coupling with the interposition of a first damping assembly (24) forming a damping layer between the first end portion (15) and the first coupling seat (16).

### RELATED APPLICATIONS

This application claims the priority benefit of Italian Pat. App. No. 102024000021061, filed on Sep. 20, 2024 in the name of Cembre S.p.A., the entire contents of which are hereby incorporated by reference.

### BACKGROUND

The object of this invention is a portable impact wrench with an electric motor and battery, specifically for screwing and unscrewing bolts, nuts, and screws on rails and sleepers in the construction and maintenance of railway lines. In particular, the subject of this invention is a so-called “T-type” wrench consisting of an upper handle unit, a lower working (screwing) unit, and an intermediate connecting tube that connects the handle unit with the working assembly. “T-type” wrenchs allow for the execution of screwing and unscrewing operations in which the operator stands upright and holds the wrench in an upright position to perform work at ground level.

The tasks listed above are physically demanding and repetitive, requiring postures that can quickly fatigue the operator's muscles. The screwing and unscrewing operations involve considerable acoustic noise and mechanical vibrations due to the percussion mechanism, the reduction mechanism, and the frictional interaction of the bolts, nuts, and screws with the components to be screwed or unscrewed. Furthermore, the use of the wrench in severe environmental conditions exposes the wrench not only to intense mechanical stresses, but also to humidity, drops and splashes of water, dust, pebbles, and metal powders that are inevitably present at the railway rails or other on-site applications.

Noise and vibrations, in combination with the weight of the wrench, constitute arduous conditions for the operator that have not yet been satisfactorily resolved.

In addition, mechanical vibrations and exposure to dust and moisture contribute to the deterioration of the mechanical and electrical/electronic parts of the wrench. Attempts at damping in the connection regions between the handle assembly and the wrench working group show only partial results due to the presence of undamped “bridges”, given by the anti-rotation, axial and transverse coupling constraints between the wrench groups.

The heating of the wrench's motor and electric power board must be limited by forced ventilation to avoid overheating of the motor and electrical/electronic components. However, the same forced ventilation tends to suck dust, moisture, and water droplets into the wrench housing, thereby increasing the risk of damage to electrical and electronic components.

The direct coupling of the battery to the wrench should ideally take place in a position and mode of engagement that allow easy insertion and disconnection of the battery, but that do not create anti-ergonomic encumbrances or imbalances when using the wrench.

In the prior art, the batteries arranged on one side of the wrench facing away from the operator are uncomfortable to insert and extract, but do not create anti-ergonomic encumbrances in the space between the wrench and the operator. The batteries arranged on one side of the wrench facing the operator are more easily inserted and removed from the battery compartment, but create an encumbrance between the wrench and the operator that forces the operator to use the wrench at a greater distance from his center of gravity, straining the arms, shoulders and back. Positioning the battery on a lateral side of the wrench would not create anti-ergonomic encumbrances, but would make it less easy to couple and decouple the battery with the wrench and would unbalance the wrench asymmetrically with respect to a plane of alignment between the operator and the wrench.

From the point of view of the initial manufacturing and maintenance of “T-type” wrenchs, the wiring between the handle assembly and the working assembly, through the intermediate connection tube, and the subsequent access to the wiring, is time-consuming.

### SUMMARY OF THE DISCLOSURE

The purpose of this invention is therefore to provide an improved impact wrench, with characteristics that can overcome at least some of the drawbacks mentioned with reference to the prior art.

This purpose is achieved by means of an impact wrench, in particular of the “T-type” according to claim 1. The dependent claims concern preferred and advantageous embodiments.

### BRIEF DESCRIPTION OF THE FIGURES

To better understand the invention and appreciate its advantages, some non-limiting exemplary embodiments will be described below, with reference to the attached figures, in which:

FIGS. 1 and 2 are perspective views of an impact wrench according to one embodiment;

FIGS. 3, 4, 5, 6, 7, 8 are top (upper side, FIG. 3), bottom (lower side, FIG. 4), front (side facing away from the operator, FIG. 5), rear (side facing the operator, FIG. 6) and side (FIG. 7, 8) views of an upper wrench handle assembly according to one embodiment;

FIG. 9 is a longitudinal sectional view of the wrench according to one embodiment;

FIG. 10 is a perspective view of the wrench handle assembly, in which a battery seat is visible with the battery removed, according to one embodiment;

FIG. 11 is an exploded perspective view of the wrench handle assembly according to one embodiment;

FIG. 12 is an exploded perspective view of a wrench connecting bar according to one embodiment;

FIG. 13 is an exploded perspective view of a lower working assembly of the wrench according to one embodiment;

FIGS. 14A, 14B, 14C are illustrations of a ventilation and cooling system of the wrench's working group according to one embodiment.

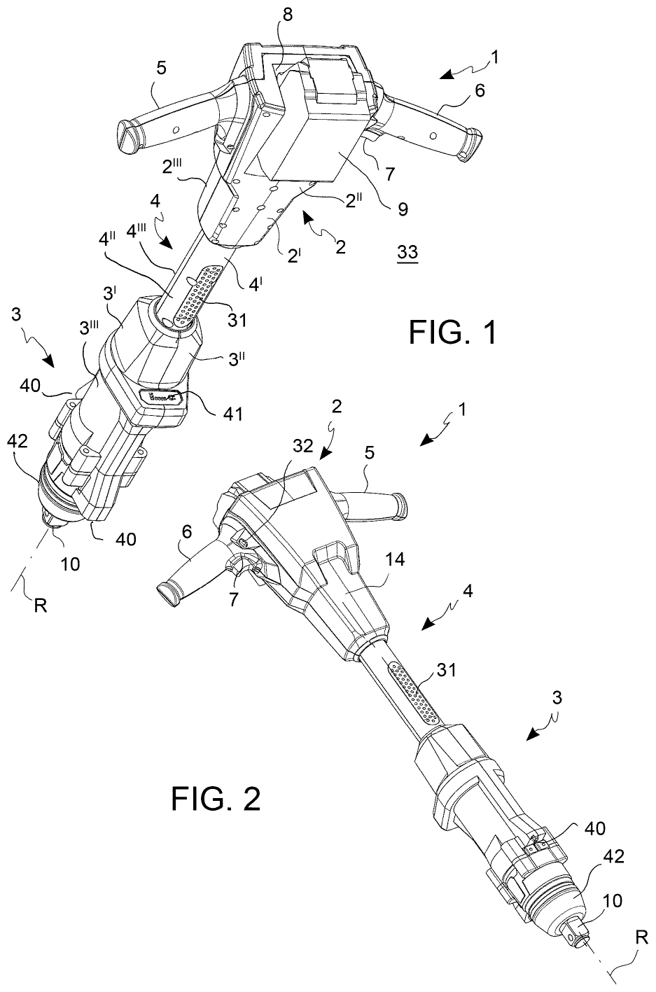

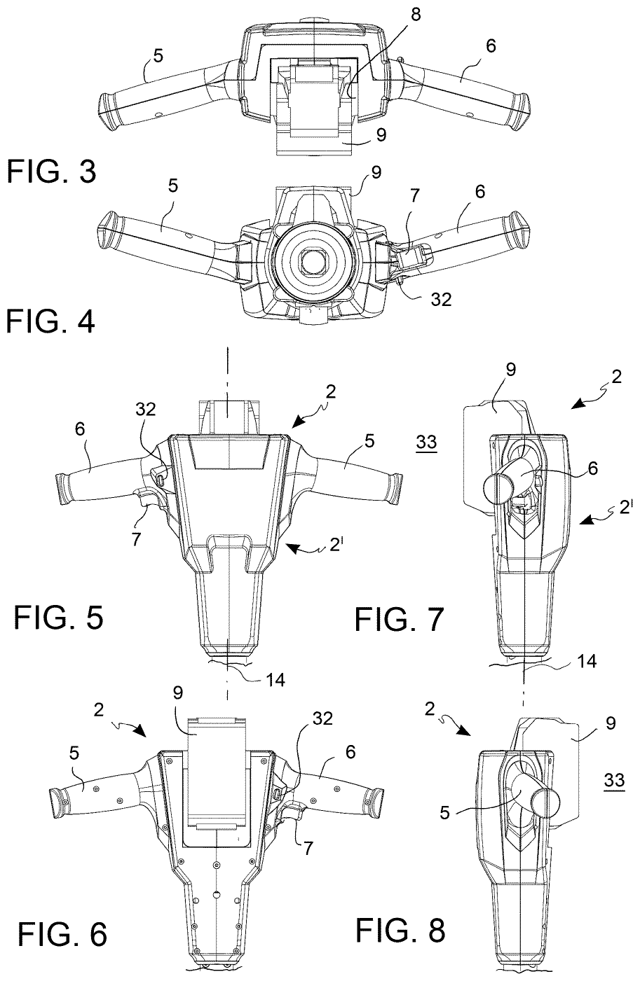

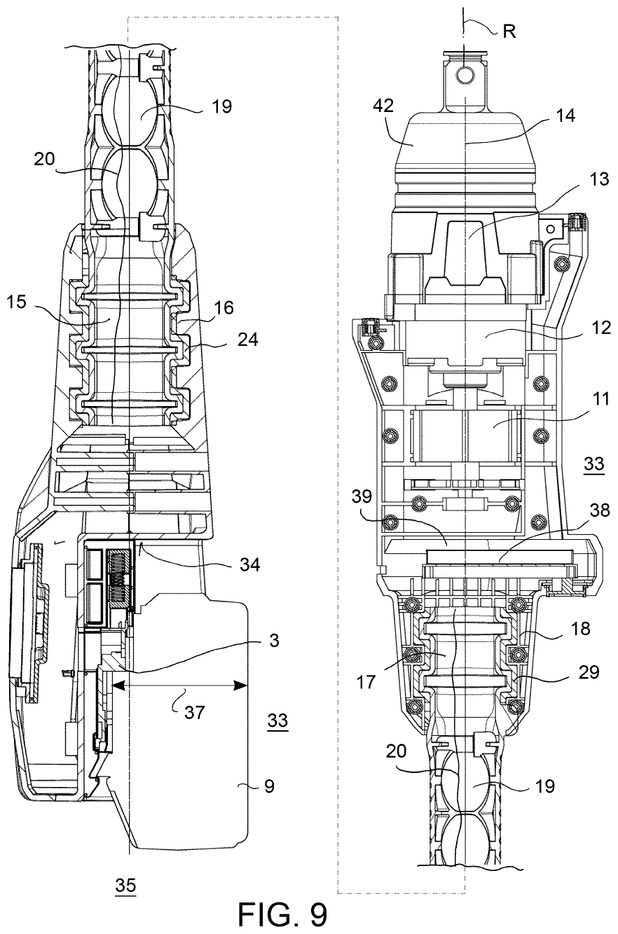

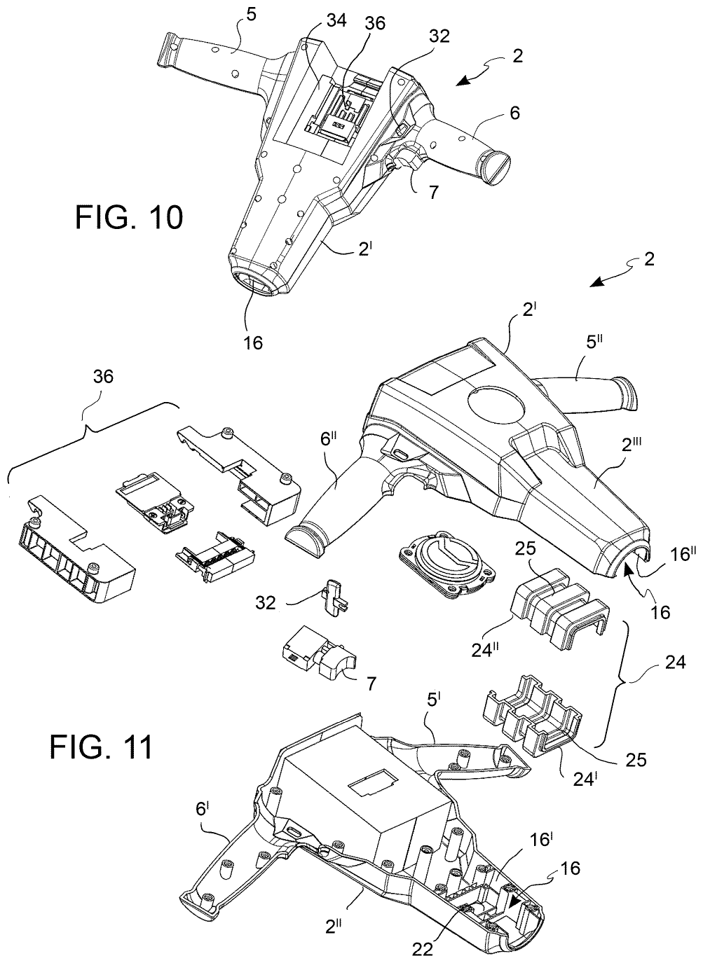

### DETAILED DESCRIPTION

### Description of the Wrench 1

With reference to the figures, a wrench 1 comprises an overall “T” shaped structure with an (upper) handle assembly 2, a (lower) working assembly 3 and an (intermediate) connecting bar 4 connected between the handle assembly 2 and the working assembly 3.

The handle assembly 2 comprises a first body 2′ with two gripping handles 5, 6 of elongated shape and extended in opposite directions to each other and transverse with respect to a longitudinal direction 14 of the wrench, so as to form a gripping handle bar. The handle assembly 2 also comprises a manual operating member 7 and a battery seat 8 to (reversibly) accommodate a battery (electric, rechargeable) 9.

The working assembly 3 comprises a second body 3′, a tool-holder shaft 10, supported in a rotatable manner around a rotation axis R and adapted to support a bushing or similar tools to engage the nuts or heads of the screws to be screwed or unscrewed.

The working assembly 3 also includes an electric motor 11, e.g. a brushless electric motor, powered by the battery 9 and capable of producing kinetic energy, in particular the rotary motion necessary for screwing/unscrewing operations. The motor 11 can be operated and controlled by the manual operating device 7, for example a push-button or trigger switch.

The working assembly 3 also comprises a transmission 12 and a percussion mechanism 13 arranged between the motor 11 and the tool-holder shaft 10, so as to transmit the rotary motion (transforming its angular velocity and torque) from the motor 11 to the tool-holder shaft 10 to rotate the latter around the axis of rotation R and impart percussion pulses.

The motor 11, transmission 12, and percussion mechanism 13 assembly substantially develops along the axis of rotation R, advantageously parallel to the longitudinal direction 14 of the wrench 1.

The connecting bar 4 comprises a third tubular body 4′, with a first end portion 15 coupled with a first coupling seat 16 of the first body 2′, and a second end portion 17 coupled with a second coupling seat 18 of the second body 3′. The third body 4′ forms an internal channel 19 for the extension of electrical cables 20 between the handle assembly 2 and the working assembly 3.

### Description of the Coupling and Damping System

According to one aspect of the invention, the first end portion 15 forms one or more first anti-extraction steps 21 extending in a direction transverse to the longitudinal direction 14, for example extending all around the third body 4′, and the first coupling seat 16 forms one or more first anti-extraction counter-steps 22, extending in a direction transverse to the longitudinal direction 14, for example extending all around the first coupling seat 16. The first anti-extraction steps 21 and the first anti-extraction counter-steps 22 are of a complementary shape, so as to create an integral connection in the longitudinal direction 14 and, at the same time, an interstice that accommodates a first damping assembly 24 (damping layer) between the first end portion 15 and the first coupling seat 16.

The first damping assembly 24 can be made of elastomeric material, for example nitrile rubber (NBR) and can be a single or multi-piece body.

The first damping assembly 24 forms (preferably also in an undeformed state):
one or more first folds 25 extending in a direction transverse to the longitudinal direction 14, for example extending all around the first damping assembly 24 and all around the first end portion 15 or all around the first coupling seat 16, and having a shape complementary to the shape of the first anti-extraction steps 21 and to the shape of the first anti-extraction counter-steps 22.

Similarly, the second end portion 17 forms one or more second anti-extraction steps 26 extending in a direction transverse to the longitudinal direction 14, for example extending all around the third body 4′, and the second coupling seat 18 forms one or more second anti-extraction counter-steps 27, extending in a direction transverse to the longitudinal direction 14, for example extending all around the second coupling seat 18. The second anti-extraction steps 26 and the second anti-extraction counter-steps 27 are of a complementary shape, so as to create an integral connection in the longitudinal direction 14 and, at the same time, an interstice that accommodates a second damping assembly 29 (damping layer) between the second end portion 17 and the second coupling seat 18.

The second damping 29 can be made of elastomeric material, for example nitrile rubber (NBR) and can be a single or multi-piece body.

The second damping assembly 29 forms (preferably also in an undeformed state):
one or more second folds 30 extending in a direction transverse to the longitudinal direction 14, for example extending all around the second damping assembly 29 and all around the second end portion 17 or all around the second coupling seat 18, and having a shape complementary to the shape of the second anti-extraction steps 26 and to the shape of the second anti-extraction counter-steps 27.

This coupling and damping configuration between the connecting bar 4 and the first body 2′ and/or the second body 3′ ensures a reliable mechanical constraint in the longitudinal direction 14 and a continuous, uninterrupted vibrational insulation in the entire coupling region.

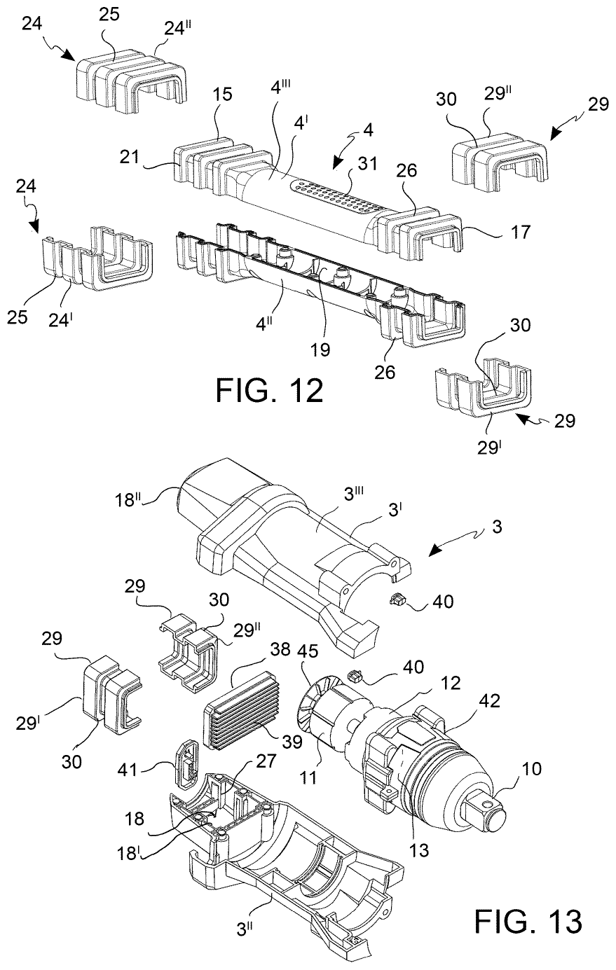

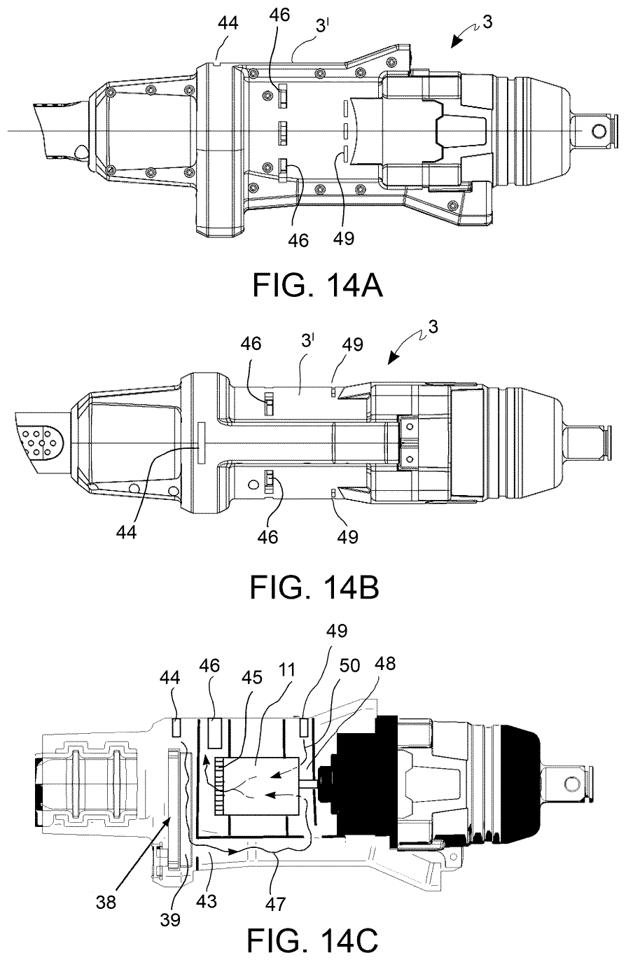

According to one embodiment, the first anti-extraction steps 21, the first anti-extraction counter-steps 22 and the first folds 25 form a plurality of, for example two or three, annular grooves and protrusions (not necessarily circular in shape, but possibly also polygonal in shape), advantageously extended in planes orthogonal to the longitudinal direction 14 (FIG. 12). This ensures a very uniform coupling stiffness and vibrational insulation all around the first end portions 15 of the third body 4′.

Similarly, the second anti-extraction steps 26, the second anti-extraction counter-steps 27 and the second folds 30 form a plurality of, for example two or three, annular grooves and protuberances (not necessarily circular in shape, but possibly also polygonal in shape), advantageously extended in planes orthogonal to the longitudinal direction 14 (FIG. 12). This ensures a very uniform coupling stiffness and vibrational insulation all around the second end portions 17 of the third body 4′.

According to one embodiment, the first damping assembly 24 (and/or similarly the second damping assembly 29) comprises two first damping half-shells 24′, 24″ (and/or similarly second damping half-shells 29′, 29″), preferably of identical and symmetrical shape with respect to a plane of separation and adjoining between them, which is preferably a plane radial to the longitudinal direction 14.

This allows for easier positioning of the damping assemblies 24, 29 in the gap between the end portions 15, 17 of the connecting bar 4 and the coupling seats 16, 18 of the handle assembly 2 and the working assembly 3, avoiding the need to fit the damping assemblies 24, 29 on the connecting bar 4 against the resistance of the anti-extraction steps 21, 26.

Advantageously, the first coupling seat 16 (and/or similarly the second coupling seat 18) also comprises two first half-shells 16′, 16″ (and/or similarly second half-shells 18′, 18″), preferably of identical and symmetrical shape with respect to a plane of separation and adjoining between them, which is preferably a plane radial to the longitudinal direction 14.

This allows the first half-shells 16′, 16″ of the first coupling seat 16 (and/or similarly the second half-shells 18′, 18″ of the second coupling seat 18) to be applied from two opposite sides on the first end portion 15 (and/or similarly on the second end portion 17) of the connecting bar 4 (and on the respective damping assembly 24, 29), avoiding the need for longitudinal insertion against the resistance of the anti-extraction steps 21, 26.

During assembly, the two half-shells of the first damping assembly 24 and/or the second damping assembly 29 are applied respectively from two opposite sides on the first and/or second end portion 15, 17 of the connecting bar 4, and the two half-shells of the first coupling seat 16 and/or the second coupling seat 18 are applied from two opposite sides and closed respectively around the first damping assembly 24 and/or the second damping assembly 29.

In accordance with a further independent aspect of the invention, but which is also synergistic in combination with the other aspects described, the first end portion 15 and the first coupling seat 16 both have a non-circular cross-section (orthogonal to the longitudinal direction 14), preferably polygonal, for example rectangular or square, possibly with rounded corners, so as to create an anti-rotation shape coupling between them, with the interposition of a first damping assembly (24) forming a damping layer between the first end portion (15) and the first coupling seat (16). This advantageously obviates the need to use anti-rotation pins which, in the prior art, are inserted into transverse holes of the components to be coupled, and in this way create unwanted vibrational bridges between them. Furthermore, the non-circular shape of the first damping assembly 24 and the damping layer formed by it creates an isolation and damping of the rotational vibrations generated by the tangential/rotational impacts made by the percussion mechanism 13.

With further advantage, the first damping assembly 24 also has (even in a non-deformed configuration) a non-circular cross-sectional shape (orthogonal to the longitudinal direction 14), and complementary to the cross-sectional shapes of the first end portion 15 and the first coupling seat 16.

Similarly, also or only the second end portion 17 and the second coupling seat 18 both have a non-circular cross-section (orthogonal to the longitudinal direction 14), preferably polygonal, for example rectangular or square, possibly with rounded corners, so as to create an anti-rotation shape coupling between them, with the interposition of a second damping assembly (29) forming a damping layer between the second end portion (17) and the second coupling seat (18). This advantageously obviates the need to use anti-rotation pins which, in the prior art, are inserted in transverse holes of the components to be coupled, and in this way create unwanted vibrational bridges between them. Also in this case, the non-circular shape of the second damping assembly 29 and of the damping layer formed by it creates an isolation and damping of the rotational vibrations generated by the tangential/rotational impacts carried out by the percussion mechanism 13.

With a further assembly and functional advantage, the second damping assembly 29 also has (even in a non-deformed configuration) a non-circular cross-sectional shape (orthogonal to the longitudinal direction 14), and complementary to the cross-sectional shapes of the second end portion 17 and the second coupling seat 18.

With the aim of effectively damping and isolating the vibrations of the wrench 1, considering the different inertial masses of the handle unit 2 and the working assembly 3, as well as the difference in distance of the coupling regions from the vibration generation locations (transmission 12, percussion mechanism 13 and motor 11), it is advantageous to make the first damping assembly 24 and the second damping assembly 29 with different shapes and sizes, for example with a number of first folds 25 different from the number of second folds 30 and/or with a spacing of the first folds 25 different from a spacing of the second folds 30.

According to one embodiment, the third body 4′ of the connecting bar 4 is made of polymeric material reinforced with fibers, for example glass fibers, reducing the weight of the wrench 1 compared to the prior art in which the connecting bar is a metal tube.

The third body 4′ comprises two half-shells 4″, 4′″ in the shape of an open channel, both extended over the entire longitudinal length of the third body 4′ and reversibly adjoinable to each other along an adjoining plane, for example corresponding to a plane radial to the longitudinal direction 14, and lockable to each other by means of connecting screws. This allows the half-shells 4″, 4′″ of the third body 4′ to be applied from two opposite sides on the electric power cables 20 during assembly in the factory and to close it around the cables 20 without having to interrupt the continuity of the cables 20 themselves. The proposed configuration also allows, during maintenance operations, quick access to the cables by simply removing the two half-shells 4′ laterally. 4″ of the third body 41′.

Advantageously, the connecting bar 4 forms one or more transport handle areas 31 made of synthetic material (for example, elastomeric or soft polymeric and/or non-slip surface, for example, made of a material different from the fiber-reinforced material of the third body 4′), for example, overmolded on the third body 4′, preferably on two diametrically opposite sides of the third body 4′.

According to one embodiment, the one or more transport handle areas 31 are formed in a position not centered with respect to the longitudinal extension of the connecting bar 4, but closer to the working assembly 3 (which is heavier) with respect to the handle unit 2, and therefore close to the center of gravity of the wrench 1.

In order to avoid errors in the assembly of the connecting bar 4, the first end portion 15 has a shape that is not compatible with the shape of the second coupling seat 18 and the second end portion 17 has a shape that is not compatible with the shape of the first coupling seat 16.

According to one embodiment, at least in correspondence with the one or more transport handle areas 31, the third body 4′ forms a cylindrical outer surface that facilitates the transport and manual handling of the wrench 1. The variation in the section of the third body 4′ between the transport handle areas 31 and the end portions is easily achieved by injection molding the half-shells 4″, 4′″ in fiber-reinforced synthetic material.

### Description of the Handle Assembly 2

According to one embodiment, the first body 2′ comprises two half-shells 2″, 2′″ made of plastic material, preferably reinforced with fibers (for example glass), connected to each other by means of connecting screws in such a way as to form a hollow body, which is more easily optimized (by means of appropriate reinforcement ribs and hollow lightening areas) for greater lightness and mechanical resistance compared to a single body.

Advantageously, each of the two half-shells 2″, 2′″ of the first body 2 forms respectively one of the first two half-shells 16′, 16″ of the first coupling seat 16.

With the further advantage of manufacturing economy and weight minimization, both gripping handles 5, 6 are hollow and formed by two half-shells 5′, 5″; 6′, 6″ connected to each other, and each of the two half-shells 2″, 2′″ of the first body 2 forms one of the two half-shells 5′, 5″; 6′, 6″ of each of the two gripping handles 5, 6 (FIG. 6).

The first body 2′ accommodates, in addition to the manual operating member 7, also a direction switch 32, for example a tri-stable switch for selecting the screwing and unscrewing direction, as well as the wrench lock.

According to one aspect (independent, but also synergistic) of the invention, the gripping handles 5, 6 are not aligned along a straight line, and have a mirrored and symmetrical position and orientation with respect to a radial plane in the longitudinal direction 14, with a first inclination towards the working assembly 3 and with a second inclination towards an operator side 33 of the wrench 1. This configuration of the gripping handles 5, 6 creates a particularly ergonomic handlebar structure that reduces the fatigue of the operator's arms and shoulders and allows, during the use of the wrench 1, a reduction of the horizontal distance between the operator's hands and the operator's center of gravity/back, even when the battery 9 is arranged on the same operator side 33 of the wrench.

According to one embodiment, the battery seat 8 consists of a cavity 34 formed in an external surface of the first body 2′ on the operator side 33. The cavity 34 is open towards the outside of the first body 2′ on the operator side 33 and on an upper side 35 of the wrench 1 opposite the working assembly 3.

Advantageously, the cavity 34 accommodates the battery 9 for at least half of its thickness 37 measured in the direction towards the operator side 33.

With further advantage, the battery 9 protrudes towards the operator side 33, beyond the free ends of the gripping handles 5, 6, by less than a third, preferably less than a quarter of the battery thickness 37 measured in the direction towards the operator side 33.

According to one embodiment, the handle assembly 2 comprises a battery interface 36 for mechanical coupling and electrical connection with the battery 9, initially separated and subsequently connected to the first body 2′ at the battery seat 8. In this way, during manufacturing, the wrench 1 can be adapted to accommodate different electric batteries, by mounting different battery interfaces 36.

### Description of the Working Assembly 3

According to one embodiment, the second body 3′ comprises two half-shells 3″, 3′″ made of plastic material, preferably reinforced with fibers (for example glass fibers), connected to each other by means of connecting screws in such a way as to form a hollow body, which is more easily optimized (by means of suitable reinforcement ribs and hollow lightening areas) for greater lightness and mechanical strength compared to a single body.

Advantageously, each of the two half-shells 3″, 3′″ of the second body 3 respectively forms one of the two second half-shells 18′, 18″ of the second coupling seat 18.

The second body 3′ houses an electrical control board 38 connected/resined with a heat sink 39, as well as the electric motor 11. The positioning of the electrical control board 38 in the same second body 3′ which also houses the motor 11 (in contrast to the positioning of the same control board in the handle assembly in the prior art) allows for simpler and more direct wiring and a synergistic configuration of the cooling system of both the motor and electrical board components.

The second body 3′ houses a lighting device 40, for example two illuminators, for example LEDs, oriented towards one end of the tool holder shaft 10, positioned in diametrically opposite positions and, preferably, in different longitudinal positions (along the longitudinal direction 14). The lighting device 40 is controlled by the electrical control board 38 depending on the operation of the manual operating member 7 and/or the direction switch 32.

According to one embodiment, the second body 3′ also houses a display 41 with a selection push-button panel directly fixed on the electrical control board 38 and which allows a selection of torque and/or screwing/unscrewing speed. The positioning of the display 41 on the second body 3′ instead of on the handle assembly 2 also allows the display and the push-button panel to be arranged directly on the electrical control board 38 and economizes the wiring and electrical connections.

According to one embodiment, the transmission 12 and the percussion mechanism 13 can be housed in their own metal housing 42 screwed to the second body 3′.

### Description of the Cooling System

According to a further independent aspect of the invention, but synergistic in combination with the other aspects described, the second body 3′ forms:
a first cooling duct 43 extended, in order:
   from one or more first inlet openings 44,
   along the heat sink 39 of the electrical board 38,
   through or along the electric motor 11,
   along a cooling fan 45 of the electric motor 11,
   and finally through one or more outlet openings 46,
wherein the cooling fan 45 generates a first cooling flow 47 along the first cooling duct 43 to cool the electrical control board 38,
as well as a second cooling duct 48 extended, in order:
   from one or more second inlet openings 49 different and distant from the first inlet opening 44,
   through or along the electric motor 11, but without first touching the heat sink 39 of the electric circuit board 38,
   along the cooling fan 45 of the electric motor 11,
   and finally through one or more outlet openings 46,
wherein the cooling fan 45 generates a second cooling flow 50 along the second cooling duct 48 to cool the electric motor 11.

The cooling configuration with two distinct cooling flows reconciles the cooling needs of the thermo-sensitive components with the need to protect sensitive components from moisture and dust sucked from the working area of the wrench 1.

The present disclosure includes also:
an impact wrench (1), having an overall “T” shape and comprising an upper handle assembly (2), a lower working assembly (3) and an intermediate connecting bar (4) connected between the handle assembly (2) and the working assembly (3), wherein:
   the handle assembly (2) comprises a first body (2′) with two elongated gripping handles (5, 6) extending in opposite directions and transverse to a longitudinal direction (14) of the impact wrench (1), a manual operating member (7) and a battery seat (8) for receiving an electric battery (9),
   the working assembly (3) comprises a second body (3′), a tool-holder shaft (10), supported in a rotatable manner around a rotation axis (R) and adapted to support a screwing bush, an electric motor (11) that can be powered by the battery (9) and operated by the manual operating member (7), a transmission (12) and a percussion mechanism (13) connected between the motor (11) and the tool-holder shaft (10) to impart a rotation and percussion pulses,
   wherein:
   the battery seat (8) is formed by a cavity (34) formed in an external surface of the first body (2′) on an operator side (33) of the impact wrench (1), wherein the cavity (34) is open towards the outside of the first body (2′) on the operator side (33) and on an upper side (35) of the impact wrench (1) opposite the working assembly (3),
   the cavity (34) accommodates the battery (9) for at least half of its thickness (37) measured in the direction towards the operator side (33) and/or the battery (9) protrudes towards the operator side (33), beyond the free ends of the gripping handles (5, 6), of less than a third, or less than a quarter, of the battery thickness (37) measured in the direction towards the operator side (33).

The present disclosure includes also
an impact wrench (1), with an overall “T” shape and comprising an upper handle assembly (2), a lower working assembly (3) and an intermediate connecting bar (4) connected between the handle assembly (2) and the working assembly (3), wherein:
   the handle assembly (2) comprises a first body (2′) with two elongated gripping handles (5, 6) extending in opposite directions and transverse to a longitudinal direction (14) of the impact wrench (1), a manual operating member (7) and a battery seat (8) for housing an electric battery (9),
   the working assembly (3) comprises a second body (3′) , a tool-holder shaft (10), supported in a rotatable manner around a rotation axis (R) and adapted to support a screwing bush, an electric motor (11) that can be powered by the battery (9) and operated by the manual operating member (7), a transmission (12) and a percussion mechanism (13) connected between the motor (11) and the tool-holder shaft (10) to impart a rotation and percussion pulses,
   wherein: the second body (3′) accommodates an electrical control board (38) with a heat sink (39) and the electric motor (11) and forms a first cooling duct (43) extended, in order:
from one or more first inlet openings (44),
along the heat sink (39) of the electrical board (38),
through or along the electric motor (11),
along a cooling fan (45) of the electric motor (11),
and finally through one or more outlet openings (46),
wherein the cooling fan (45) generates a first cooling flow (47) along the first cooling duct (43) to cool the electrical control board (38),
   the second body (3′) forms a second cooling duct (48) extended, in order:
from one or more second inlet openings (49) different and distant from the first inlet opening (44),
through or along the electric motor (11), but without first touching the heat sink (39) of the electrical board (38),
along the cooling fan (45) of the electric motor (11),
and finally through one or more outlet openings (46), wherein the cooling fan (45) generates a second cooling flow (50) along the second cooling duct (48) to cool the electric motor (11).

### REFERENCES

wrench 1
(upper) handle assembly 2
first body 2′
half-shells 2″, 2′″ of the first body 2′ (lower) working assembly 3
second body 3′
half-shells 3″, 3′″ of the second body 3′ (intermediate) connecting bar 4
third body 4′
half-shells of the third body 4″, 4′″
gripping handles 5, 6
manual operating part 7
battery seat 8
battery 9
tool-holder shaft 10
rotation axis R
electric motor 11
transmission or gearbox 12
percussion mechanism 13
longitudinal direction 14
first end portion 15
first coupling seat 16
first half-shells 16′, 16″ of the first coupling seat
second end portion 17
second coupling seat 18
second half-shells 18′, 18″ of the second coupling seat
internal channel 19
electric cables 20
first anti-extraction steps 21
first anti-extraction counter-steps 22-23
first damping assembly 24
first damping half-shells 24′, 24″
first folds 25
second anti-extraction steps 26
second anti-extraction counter-steps 27-28
second damping assembly 29
second damping half-shells 29′, 29″
second folds 30
transport handle areas 31
direction switch 32
operator side 33
cavity 34 for battery seat
upper side 35
battery interface 36
battery thickness 37
electrical control board 38
heat sink 39
lighting device 40
display 41
metal housing 42
first cooling duct 43
first inlet openings 44
cooling fan 45
outlet openings 46
first cooling flow 47
second cooling duct 48
second inlet openings 49
second cooling flow 50

1. An impact wrench, with an overall “T” shape and comprising an upper handle assembly, a lower working assembly and an intermediate connecting bar connected between the handle assembly and the working assembly, wherein:
the handle assembly comprises a first body with two elongated gripping handles extending in opposite directions and transverse to a longitudinal direction of the impact wrench, a manual operating member and a battery seat for receiving an electric battery,
the working assembly comprises a second body, a tool-holder shaft, supported in a rotatable manner around an axis of rotation and adapted to support a screwing bush, an electric motor that can be powered by the battery and operable by the manual operating member, a transmission and a percussion mechanism connected between the motor and the tool-holder shaft to impart a rotation and percussion pulses,
the connecting bar comprises a third, tubular body, with a first end portion coupled with a first coupling seat of the first body, and a second end portion coupled with a second coupling seat of the second body,
wherein:
(A) the first end portion and the first coupling seat both have a non-circular or polygonal or rectangular or square cross section, orthogonal to the longitudinal direction, so as to create an anti-rotation shape coupling with the interposition of a first damping assembly forming a damping layer between the first end portion and the first coupling seat, and/or
(B) the second end portion and the second coupling seat both have a non-circular or polygonal or rectangular or square cross section, orthogonal to the longitudinal direction, so as to create an anti-rotation shape coupling with the interposition of a second damping assembly forming a damping layer between the second end portion and the second coupling

2. The impact wrench of claim 1, comprising feature (A) and wherein the first damping assembly has, even in a non-deformed configuration, a non-circular cross-sectional shape, complementary to the cross-sectional shapes of the first end portion and the first coupling seat.

3. The impact wrench of claim 1, comprising feature (B) and wherein the second damping assembly has, even in a non-deformed configuration, a non-circular cross-sectional shape, complementary to the cross-sectional shapes of the second end portion and the second coupling seat.

4. The impact wrench of claim 1, wherein
(A1) the first end portion forms one or more first anti-extraction steps extending in a direction transverse to the longitudinal direction, and the first coupling seat forms one or more first anti-extraction counter-steps, extending in a direction transverse to the longitudinal direction, and the first anti-extraction steps and the first anti-extraction counter-steps are of a complementary shape to create a connection fixed the longitudinal direction, and with an interstice that accommodates a first damping assembly forming a damping layer between the first end portion and the first coupling seat, and/or
(B1) the second end portion forms one or more second anti-extraction steps extending in a direction transverse to the longitudinal direction, and the second coupling seat forms one or more second anti-extraction counter-steps extending in a direction transverse to the longitudinal direction, and the second anti-extraction steps and the second anti-extraction counter-steps are of a complementary shape to make a connection fixed in the longitudinal direction, and with an interstice that accommodates a second damping assembly forming a damping layer between the second end portion and the second coupling seat.

5. The impact wrench of claim 4, comprising feature (A1) and wherein the first anti-extraction steps extend all around the third body and the first anti-extraction counter-steps extend all around the first coupling seat.

6. The impact wrench of claim 4, comprising feature (A1) and wherein the first damping assembly forms, even in a non-deformed state, one or more first folds extended in a transverse direction to the longitudinal direction and having a complementary shape with the shape of the first anti-extraction steps and with the shape of the first anti-extraction counter-steps.

7. The impact wrench of claim 6, wherein the first folds are extended:
all around the first damping assembly, and
all around the first end portion or all around the first coupling seat.

8. The impact wrench of claim 6, wherein the first anti-extraction steps, the first anti-extraction counter-steps and the first folds form a plurality of annular grooves and protuberances, extended in planes orthogonal to the longitudinal direction.

9. The impact wrench of claim 1, comprising the feature (B1) and wherein the second anti-extraction steps extend all around the third body and the second anti-extraction counter-steps extend all around the second coupling seat.

10. The impact wrench of claim 1, comprising feature (B1) and wherein the second damping assembly forms, even in a non-deformed state, one or more second folds extended in a direction transverse to the longitudinal direction and having a shape complementary to the shape of the second anti-extraction steps and to the shape of the second anti-extraction counter-steps.

11. The impact wrench of claim 10, wherein the second folds are extended:
all around the second damping assembly, and
all around the second end portion or all around the second coupling seat.

12. The impact wrench of claim 10, wherein the second anti-extraction steps, the second anti-extraction counter-steps and the second folds form a plurality of annular grooves and protuberances, extended in planes orthogonal to the longitudinal direction.

13. The impact wrench of claim 1,
comprising characteristic (A) and wherein the first damping assembly comprises two first damping half-shells, and/or
comprising feature (B) and wherein the second damping assembly comprises two second damping half-shells.

14. The impact wrench of claim 1,
comprising characteristic (A) and wherein the first damping assembly comprises two first damping half-shells of identical shape and positioned symmetrically with respect to a plane of separation and adjoining between them, which is a radial plane to the longitudinal direction, and/or
comprising characteristic (B) and wherein the second damping assembly comprises two second damping half-shells of identical shape and positioned symmetrically with respect to a plane of separation and adjoining between them, which is a radial plane to the longitudinal direction.

15. The impact wrench of claim 1, wherein the first coupling seat comprises two first half-shells and the second coupling seat comprises two second half-shells.

16. The impact wrench of claim 1, comprising feature (A) and feature (B), wherein the first damping assembly and the second damping assembly have different shapes and sizes.

17. The impact wrench of claim 1, wherein the third body is made of fiber-reinforced polymeric material and comprises two half-shells in the shape of an open channel, both extended over the entire longitudinal length of the third body and reversibly approachable and lockable to each other by means of connecting screws.

18. The impact wrench of claim 1, wherein the connecting bar forms one or more transport handle areas in synthetic material different from the fiber-reinforced material of the third body and overmolded on the third body.

19. The impact wrench of claim 18, wherein the center of gravity of the impact wrench is closer to the working assembly than to the handle unit and the carrying handle areas are made on two diametrically opposite sides of the third body and in positions not centered with respect to the longitudinal extension of the connecting bar, but closer to the working assembly than to the handle unit, and
wherein the first end portion has a shape that is not compatible with the shape of the second coupling seat and the second end portion has a shape that is not compatible with the shape of the first coupling seat.

20. The impact wrench of claim 15, wherein the first body comprises two half-shells made of plastic material, connected to each other by means of connecting screws so as to form a hollow body, wherein each of the two half-shells of the first body respectively forms one of two first half-shells of the first coupling seat.

21. The impact wrench of claim 20, wherein both gripping handles are hollow and formed by two half-shells respectively connected to each other, and each of the two half-shells of the first body forms respectively one of the two half-shells of each of the two gripping handles.

22. The impact wrench of claim 1, wherein the gripping handles have a mirrored and symmetrical position and orientation with respect to a radial plane to the longitudinal direction, and are inclined towards the working assembly and towards an operator side of the impact wrench.

23. The impact wrench of claim 1, wherein the battery seat is formed by a cavity formed in an external surface of the first body on an operator side of the impact wrench, wherein the cavity is open towards the outside of the first body on the operator side and on an upper side of the impact wrench opposite the working assembly, and
wherein the cavity accommodates the battery for at least half of its thickness measured in the direction towards the operator side and/or the battery protrudes towards the operator side, beyond the free ends of the gripping handles, of less than one third, or less than one quarter of the battery thickness measured in the direction towards the operator side.

24. The impact wrench of claim 1, wherein the handle assembly comprises a battery interface for mechanical coupling and electrical connection with the battery, wherein the battery interface is manufactured separately from and subsequently connected to the first body at the battery seat.

25. The impact wrench of claim 15, wherein the second body comprises two half-shells made of plastic material, connected to each other by means of connecting screws so as to form a hollow body, wherein each of the two half-shells of the second body respectively forms one of the two second half-shells of the second coupling seat.

26. The impact wrench of claim 1, wherein the second body accommodates an electrical control board with a heat sink, the electric motor and a lighting device.

27. The impact wrench of claim 26, wherein the lighting device comprises two illuminators or LEDs, oriented towards one end of the tool holder shaft, positioned in diametrically opposite positions and in different longitudinal positions along the longitudinal direction, wherein the lighting device is controlled by the electrical control board depending on the operation of the manual operating member and/or a direction switch of the impact wrench.

28. The impact wrench of claim 26, wherein the second body also accommodates a display with a selection push-button panel directly positioned on the electrical control board and which allows a selection of torque and/or screwing/unscrewing speed.

29. The impact wrench of claim 26,
wherein the second body forms a first cooling duct extended, in order:
from one or more first inlet openings,
along the heat sink of the electrical board,
through or along the electric motor,
along a cooling fan of the electric motor,
and finally through one or more outlet openings,
wherein the cooling fan generates a first cooling flow along the first cooling duct to cool the electrical control board,
wherein the second body forms a second cooling duct extending, in order:
from one or more second inlet openings different and distant from the first inlet opening,
through or along the electric motor, but without first touching the heat sink of the electrical circuit board,
along the cooling fan of the electric motor,
and finally through one or more outlet openings,
wherein the cooling fan generates a second cooling flow along the second cooling duct to cool the electric motor.
